(19) United States
(12) Patent Application Publication
(10) Pub. No.: US 2010/0150427 A1
(43) Pub. Date: Jun. 17, 2010

(54) PORTABLE WAFER INSPECTION SYSTEM

(75) Inventors: YUAN WEN LIU, Taoyuan County (TW); HUNG CHIH KUO, Taipei County (TW); CHENG FA TSAO, Taipei City (TW)

Correspondence Address: ROSENBERG, KLEIN & LEE, 3458 ELLICOTT CENTER DRIVE-SUITE 101, ELLICOTT CITY, MD, 21043, US

(73) Assignee: INOTERA MEMORIES, INC., Taoyuan County (TW)

(21) Appl. No.: 12/428,058

(22) Filed: Apr. 22, 2009

(30) Foreign Application Priority Data
Dec. 15, 2008 (TW) 97148707

(51) Int. Cl. G06K 9/00

(52) U.S. Cl. 382/145

(57) ABSTRACT

A portable wafer inspection system is applied on an inspection window of a manufacturing tool for wafers. The portable wafer inspection system comprises: a housing, a lighting unit, and an inspection unit. The housing has a receiving room therein, and a plurality of fixing members is disposed at the opening of the housing. The fixing members are used for fixing the housing on the inspection window of the manufacturing tool. The lighting unit and the inspection unit are disposed in the receiving room of the housing, wherein the inspection unit is for capturing images of the wafers. Thereby the inspection unit may be used for inspecting the wafers in the manufacturing tool through the inspection window

### BACKGROUND OF THE INVENTION

1. Field of the Invention

The present invention relates to a portable wafer inspection system and in particular to a portable wafer inspection system for inspecting wafers in manufacturing tools.

2. Description of Related Art

For achieving the functions of the semiconductor, the substrate of the semiconductor such as a silicon substrate is provided for some manufacturing processes. Processes such as, metal deposition, lithograph for patterning on each layers, or ion-implement. Furthermore, the circuit or the structure of the semiconductor has to be tested for determining that the results of the processes meet the requirement of the electronic design. For example, the crystalline and the depth of the metal layer are inspected after the metal deposition process.

As the critical dimension of the semiconductor device decreases, higher resolution inspection systems are developed for inspecting the semiconductor device with decreased size so that the yield and the precision of the manufacturing system can be satisfied. Traditional inspection tools includes optical microscope, scanning electron microscope (SEM), transmission electron microscope (TEM), and so on. These tools are provided for inspections such as: inspection after developing (ADI), inspection after etching (AEI), or quality control (QC) for inspecting the results after these important processes. These tools are classified into brightness field and dark field technologies, and the purpose of these inspection systems is to improve the yield of the manufacturing processes. The following is the description of a general traditional inspection system. First, the inspection system is used for inspecting a predetermined position on the wafer and the inspected value of the predetermined position is labeled as a standard value. Then, a second position of wafer is inspected and the inspected value of the second position is compared with the standard for determining the quality of the manufacturing process.

However, traditional inspection tools are fixed tools and these tools are usually fixed at a specific location, so as to be used after some critical processes. For example, the ADI tool is fixed at a specific location, so as to be used after the developing process for only inspecting the result of the developing process. In another word, the ADI tool is not used for inspecting the result of another process. If some low yield issues have happened in another process, it is not convenient for inspecting the wafer by the ADI tool. Moreover, the wafers are selected specifically for being inspected, thus the data of the inspection may be over generalized, and the samples taken not being representative, therefore can not efficiently represent the situation of the manufacturing processes.

On the other hand, the traditional method for wafer inspection is executed by human inspection. Thus, it requires a significant amount of time for inspecting wafers and the precision of the inspection is lower when compared to inspection by machine instrument. In another word, there is a need for improving the efficiency and the precision of the wafer inspection.

Therefore, in view of this, the inventor proposes the present invention to overcome the above problems based on his expert experience and deliberate research.

### SUMMARY OF THE INVENTION

The primary object of the present invention is provided a portable wafer inspection system. The portable wafer inspection system can be applied on different tools for inspecting each wafer in the tools; and when the defects on the wafers are defected, such as when the wafers are scraped or have residual chemical material, the portable wafer inspection system can notify the engineers in real time.

In order to achieve the above objects, the present invention provides a portable wafer inspection system. The portable wafer inspection system is applied on an inspection window of a manufacturing tool for wafers. The portable wafer inspection system comprises: a housing having a receiving room therein, the housing having a plurality of fixing members at the opening thereof, the fixing members being used for fixing the housing on the inspection window of the manufacturing tool; a lighting unit disposed in the receiving room of the housing; and an inspection unit disposed in the receiving room of the housing for capturing images of the wafers. The inspection unit is used for inspecting the wafers in the manufacturing tool through the inspection window.

Depending on the present invention, the portable wafer inspection system can be movably assembled on different manufacturing tools for solving the problem of the traditional inspection system being fixed, which can only be used for inspecting the wafers after a specific predetermined manufacturing process due to the traditional inspection system being fixed. Therefore, the portable wafer inspection system of the present invention can be more flexibly and more widely used in the semiconductor manufacturing application.

In order to better understand the characteristics and technical contents of the present invention, a detailed description thereof will be made with reference to the accompanying drawings. However, it should be understood that the drawings and the description are illustrative but not used to limit the scope of the present invention.

### BRIEF DESCRIPTION OF THE DRAWINGS

FIG. 1 is a schematic view showing a physical vapor deposition (PVD) tool;

FIG. 2 shows a portable wafer inspection system according to the present invention; and

FIG. 3 shows a function blocks of the portable wafer inspection system according to the present invention.

### DETAILED DESCRIPTION OF THE PREFERRED EMBODIMENTS

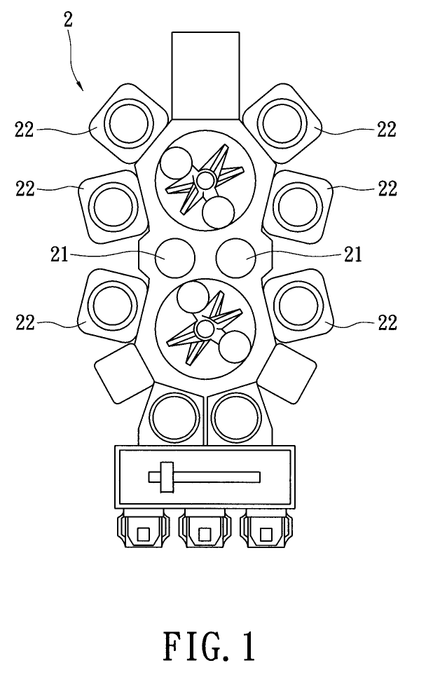

Please refer to FIGS. 1-3; the present invention discloses a portable wafer inspection system 1 and the portable wafer inspection system 1 is applied on a manufacturing tool 2 that manufactures semiconductor wafers. The portable wafer inspection system 1 is for inspecting wafers and alerting for wafers' defects in real time. The portable wafer inspection system 1 includes a hosing 10, a lighting unit 11, and an inspection unit 12. In the embodiment, the housing 10 is cylinder-shaped and has a receiving room 100 for receiving the lighting unit 11, the inspection unit 12, and other support units. Further, the housing has a plurality of fixing members 101 at the opening of the housing 10 for fixing the housing 10 to a predetermined position.

The lighting unit 11 is received in the receiving room 100 of the housing 10, and the lighting unit 11 has at lest one LED in the embodiment. The lighting unit 11 provides the lights for the inspection unit 12 so that the inspection unit 12 can capture the images of wafers with high quality.

The inspection unit 12 is received in the receiving room 100 of the housing 10, and the inspection unit 12 is a lens module with charge-coupled device (CCD) in the present embodiment. The inspection unit 12 is used for capturing the images of wafers in the manufacturing tool 2, so that the portable wafer inspection system 1 can analyze the images in real time, thereby the wafers can be efficiently inspected for defects.

Please refer to FIG. 1 again. The portable wafer inspection system 1 can be assembled on a manufacturing tool 2 for inspecting each wafer in the manufacturing processes. In the embodiment, the manufacturing tool 2 is a physical vapor deposition (PVD) tool. The portable wafer inspection system 1 can be efficiently assembled on or disassembled from the manufacturing tool 2 so that the portable wafer inspection system 1 is capable for detecting the defects on the wafers in different manufacturing processes. Generally speaking, the manufacturing tool 2 has at least one inspection window 21 so that engineers and operators can see the processing situation inside the manufacturing tool 2 though the inspection window 21, for example, the movement of robot arm. In other words, the portable wafer inspection system 1 is assembled on the inspection window 21 for capturing images of wafers inside the manufacturing tool 2.

In the FIG. 1, the manufacturing tool 2, such as a physical vapor deposition (PVD) manufacturing tool, has two inspection windows 21 and six processing chambers 22. The portable wafer inspection system 1 is assembled on the inspection window 21 by the fixing members 101, such as screws or lockers, and the inspection unit 12 is aligned with the inspection window 21. Furthermore, the inspection unit 12 can auto-focus or focus by hand on the wafers inside the manufacturing tool 2. During processing, the wafers undergoing processing are transferred between the processing chambers 22 by robot arm. When one of the wafers passes though the inspection window 21, the wafer can be stopped under the inspection window 21 for few seconds and the image of the wafer can simultaneously be captured by the inspection unit 12. In other words, the images of the wafers inside the manufacturing tool 2 can be captured by the inspection unit 12 due to the transparent property of the inspection window 21.

Furthermore, for avoiding the unclearness or unfocused images of wafers due to light pollution from outside the housing 10—such as flickering of light causes by random movements of people around the housing 10, the hosing 10 is preferably non-transparent. The hosing 10 can entirely cover the inspection window 21 for decreasing the influence of the outside environment, such as lighting. In the present embodiment, the inspection unit 12 can capture the focused images of wafers by lighting of the lighting unit 11 and the lighting pollution from outside environment is thereby avoided.

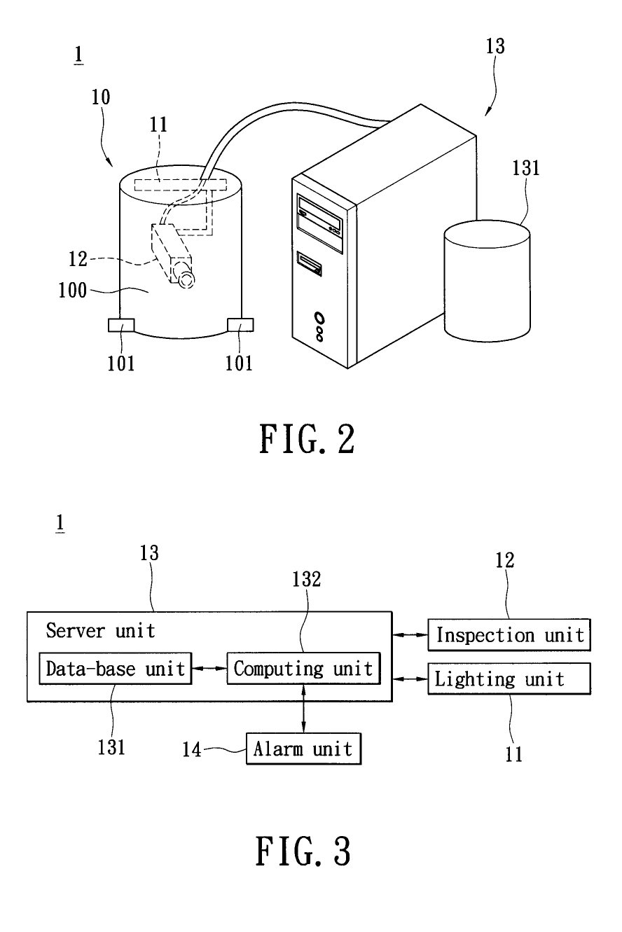

FIGS. 2-3 show the embodiment of the present invention. The portable wafer inspection system 1 further has a server unit 13 which is electrically coupled to the inspection unit 12. The server unit 13 is used for storing and analyzing the images of wafers captured by the inspection unit 12. The server unit 13 includes a data-base unit 131 for storing the images of wafers and a computing unit 132. The images of wafers captured by the inspection unit 12 are analyzed and compared by the computing unit 132 and are compressed into a kind of compressed image data, for example JPEG data. The compressed images can be stored in the data-base unit 131.

Moreover, the computing unit 132 can analyze the images by an image analyzing software for determining the linear scrape, particles, or defects on the wafers. When the defects are analyzed and determined, the computing unit 132 can output an alarm signal by an alarm unit 14 for notifying engineers or operators. The portable wafer inspection system 1 further has a display unit, and the computing unit 132 can display the images of the wafers on the display unit so that the engineer can compare the images of wafers on the display unit. The computing unit 132 can analyze the images of wafers in the data-base unit 131, for example, the length of the scrape, or the positions of the defects so that the processing data can be efficiently analyzed by analyzing the images of wafers.

Accordingly, the portable wafer inspection system 1 can be assembled on different manufacturing tools and is not fixed to one particular position to a particular manufacturing tool. The different manufacturing tool may be for example, PVD tool, etching tools, or developer tools. The inspection unit 12 of the portable wafer inspection system 1 can capture the image of the wafers though the inspection window 21 and the captured images can be analyzed and stored by the server unit 13 so that the engineers will be notified when the defects of the wafer being processed are inspected.

To sum up, the present invention has the following advantages:
1. The present invention provides an inspection system with high inspection efficiency and high inspection precision. The lens module is used for capturing the images of wafers; and the captured images are analyzed by the computing unit so that the mistakes from human inspection are decreased. Furthermore, the captured images are analyzed by the digital computing unit for increasing the inspection efficiency.
2. The portable wafer inspection system can be assembled on different tools so that the portable wafer inspection system is suitable for inspecting the wafers for the desired processes, in other words the portable wafer inspection system is not fixed to examine only one process. The problem that the traditional inspection system is fixed to one specific tool is solved. Furthermore, the portable wafer inspection system is used for inspecting each wafer inside the tools. The problem of selecting wafers for being inspected is solved.
3. The portable wafer inspection system is an inspection module so that the portable wafer inspection system is efficiently assembled on/disassembled from the tool. The cost of portable wafer inspection system is reduced. Moreover, the portable wafer inspection system is a portable unit for solving the problem of the fixed type traditional inspection system.

Although the present invention has been described with reference to the foregoing preferred embodiment, it will be understood that the invention is not limited to the details thereof. Various equivalent variations and modifications may occur to those skilled in this art in view of the teachings of the present invention. Thus, all such variations and equivalent modifications are also embraced within the scope of the invention as defined in the appended claims.

What is claimed is:

1. A portable wafer inspection system applied on an inspection window of a manufacturing tool that manufactures semiconductors, the portable wafer inspection system comprising:
a housing having a receiving room therein, the housing having a plurality of fixing members at the opening thereof, the fixing members being used for fixing the housing on the inspection window of the manufacturing tool;
a lighting unit disposed in the receiving room of the housing; and
an inspection unit disposed in the receiving room of the housing for capturing images of wafers;
wherein the inspection unit is used for inspecting the wafers in the manufacturing tool through the inspection window.

2. The portable wafer inspection system according to claim 1, wherein the inspection unit is used for capturing images of the wafers inside the manufacturing tool through the inspection window of the manufacturing tool.

3. The portable wafer inspection system according to claim 2, further comprising a server unit electrically coupled to the inspection unit, wherein the server unit is used for storing and analyzing the images of the wafers captured by the inspection unit.

4. The portable wafer inspection system according to claim 3, wherein the server unit further has a data-base unit for storing the images of the wafers captured by the inspection unit.

5. The portable wafer inspection system according to claim 4, wherein the server unit further has a computing unit for analyzing and compressing the images of the wafers captured by the inspection unit.

6. The portable wafer inspection system according to claim 5, further comprising an alarm unit connecting with the computing unit, wherein the alarm unit is used for alerting when the computing unit found defects on the wafers through analyzing the images of the wafers.

7. The portable wafer inspection system according to claim 1, wherein the portable wafer inspection system is used for inspecting the linear scrape, particles, or defects on the wafers.

8. The portable wafer inspection system according to claim 1, wherein the housing is non-transparent.

9. The portable wafer inspection system according to claim 1, wherein the portable wafer inspection system is easily dissembled from the manufacturing tool and then assembled on another manufacturing tool.

10. A portable wafer inspection system applied on an inspection window of a manufacturing tool that manufactures semiconductors, the portable wafer inspection system comprising:
a housing having a receiving room therein, the housing having a plurality of fixing members at the opening thereof, the fixing members being used for fixing the housing on the inspection window of the manufacturing tool;
a lighting unit disposed in the receiving room of the housing; and
a lens module disposed in the receiving room of the housing for capturing images of wafers;
wherein the lens module is used for inspecting the linear scrape, particles, or defects of the wafers in the manufacturing tool through the inspection window.

11. The portable wafer inspection system according to claim 10, further comprising a server unit electrically coupled to the lens module, wherein the server unit is used for storing and analyzing the images of the wafers captured by the lens module.

12. The portable wafer inspection system according to claim 11, wherein the server unit further has a data-base unit for storing the images of the wafers captured by the lens module.

13. The portable wafer inspection system according to claim 12, wherein the server unit further has a computing unit for analyzing and compressing the images of the wafers captured by the lens module.

14. The portable wafer inspection system according to claim 13, further comprising an alarm unit connecting with the computing unit, wherein the alarm unit is used for alerting when the computing unit found defects on the wafers through analyzing the images of the wafers.

15. The portable wafer inspection system according to claim 10, wherein the housing is non-transparent.

16. The portable wafer inspection system according to claim 10, wherein the portable wafer inspection system is easily dissembled from the manufacturing tool and then assembled on another manufacturing tool.
